(19) United States
(12) Patent Application Publication
(10) Pub. No.: US 2023/0250866 A1
(43) Pub. Date: Aug. 10, 2023

(54) DRIVE CLUTCH FOR A CONTINUOUSLY VARIABLE TRANSMISSION

(71) Applicant: TEAM Industries, Inc., Bagley, MN (US)

(72) Inventor: Brandon R. Bonham, Bemidji, MN (US)

(73) Assignee: TEAM Industries, Inc., Bagley, MN (US)

(21) Appl. No.: 18/163,479

(22) Filed: Feb. 2, 2023

Related U.S. Application Data
(60) Provisional application No. 63/307,360, filed on Feb. 7, 2022.

(51) Int. Cl. F16H 55/56; F16H 9/16

(52) U.S. Cl. CPC F16H 55/563; F16H 9/16

(57) ABSTRACT

A drive clutch for a continuously variable transmission is provided. A movable sheave assembly is slidably mounted on a post. The movable sheave assembly includes a housing with an interior chamber. Spaced sheave ramps are positioned within the interior chamber. A spider is received within the housing of the moveable sheave and is statically mounted on the post. The spider includes spaced radially extending spider ramp arms. Each spider ramp arm includes at least one spider ramp. Roller centrifugal elements are received within the interior chamber of the housing of the movable sheave. Each roller centrifugal element includes a sheave ramp roller and at least one spider ramp roller. The sheave ramp roller is configured to engage one of an associated sheave ramp and associated spider ramp and the spider ramp roller is configured to engage the other of the associated sheave ramp and associated spider ramp.

### CROSS-REFERENCE TO RELATED APPLICATIONS

This application claims priority to U.S. Provisional Application Ser. No. 63/307,360, same title herewith, filed on Feb. 7, 2022, which is incorporated in its entirety herein by reference.

### BACKGROUND

A continuously variable transmission (CVT) includes a drive clutch (primary clutch) and a driven clutch (secondary clutch). The drive clutch is typically in operational communication with an engine to receive engine torque and the driven clutch is in operational communication with a driveline of an associated vehicle. The driven clutch is in rotational communication with the drive clutch via endless loop member such as a belt. The drive clutch includes a movable sheave assembly that is configured move axially on a post as rotational speed and centrifugal forces increase and decrease. The movable sheave assembly axially moves on the post either away from or towards a fixed sheave. The belt, riding on faces of the fixed and movable sheave assemblies move radially either towards a central axis of the drive clutch or away from the central axis therein changing the gear ratio of the CVT.

One common type of movable sheave assembly uses a dual ramp (sheave and spider)/centrifugal sliding element configuration to generate belt clamp forces (i.e., move the moveable sheave portion on the post towards the fixed sheave). The sliding interface of the centrifugal sliding element on the ramp surfaces creates friction. This friction results in undesired wear at the centrifugal sliding element therein limiting CVT shifting performance.

For the reasons stated above and for other reasons stated below which will become apparent to those skilled in the art upon reading and understanding the present specification, there is a need in the art for an improved and effective drive clutch with reduced wear.

### SUMMARY OF INVENTION

The following summary is made by way of example and not by way of limitation. It is merely provided to aid the reader in understanding some of the aspects of the subject matter described. Embodiments provide an improved drive clutch with a novel rolling centrifugal element assembly.

In one embodiment, a drive clutch for a continuously variable transmission is provided. The drive clutch includes a post, a fixed sheave, a movable sheave assembly, a plurality of spaced sheave ramps, a spider, and a plurality of roller centrifugal elements. The fixed sheave is statically mounted on an end of the post. The movable sheave assembly is slidably mounted on the post. The movable sheave assembly includes a housing that forms at least in part an interior chamber. The plurality of spaced sheave ramps are positioned within the interior chamber of the housing of the movable sheave assembly. The spider is received within the housing of the movable sheave assembly. The spider is statically mounted on the post. The spider includes a plurality of spaced radially extending spider ramp arms. Each spider ramp arm includes at least one spider ramp. The plurality of roller centrifugal elements are received within the interior chamber of the housing of the movable sheave. Each roller centrifugal element includes at least one sheave ramp roller and at least one spider ramp roller. The at least one sheave ramp roller is configured to engage one of an associated sheave ramp and associated spider ramp and the at least one spider ramp roller configured to engage another one of the associated sheave ramp and associated spider ramp.

In another embodiment, a rolling centrifugal element for a clutch of a continuously variable transmission is provided. The rolling centrifugal element includes an axle and at least one sheave ramp roller and at least one spider ramp roller mounted on the axle. The at least one sheave ramp roller is configured to engage one of an associated sheave ramp of a movable sheave assembly of the clutch and an associated spider ramp of a spider and the at least one spider ramp roller configured to engage another one of the associated sheave ramp and the associated spider ramp. The at least one sheave ramp roller is configured to rotate independent of the at least one sheave ramp roller.

In yet another example, a vehicle is provided. The vehicle includes an engine to produce engine torque, a driveline and a CVT. The CVT includes a driven clutch and a drive clutch. The driven clutch is in operational communication with the driveline. The drive clutch is in operational communication with the engine. The drive clutch includes a post, a fixed sheave, a movable sheave assembly, a plurality of spaced sheave ramps, a spider, and a plurality of roller centrifugal elements. The fixed sheave is statically mounted on an end of the post. The movable sheave assembly is slidably mounted on the post. The movable sheave assembly includes a housing that forms at least in part an interior chamber. The plurality of spaced sheave ramps are positioned within the interior chamber of the housing of the movable sheave assembly. The spider is received within the housing of the movable sheave assembly. The spider is statically mounted on the post. The spider includes a plurality of spaced radially extending spider ramp arms. Each spider ramp arm includes at least one spider ramp. The plurality of roller centrifugal elements are received within the interior chamber of the housing of the movable sheave. Each roller centrifugal element includes at least one sheave ramp roller and at least one spider ramp roller. The at least one sheave ramp roller is configured to engage one of an associated sheave ramp and associated spider ramp and the at least one spider ramp roller configured to engage another one of the associated sheave ramp and associated spider ramp. An endless looped member couples torque between the drive clutch and the driven clutch.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of an assembled drive clutch according to one exemplary aspect of the present invention;

FIG. 2 is a cross-sectional side perspective view of the drive clutch of FIG. 1 illustrating portions of rolling centrifugal elements in a cavity of a housing of a movable sheave assembly according to one exemplary aspect of the present invention;

FIG. 3 is an assembled side perspective view of a rolling centrifugal element according to one exemplary aspect of the present invention;

FIG. 4 is a cross-sectional side perspective view of the rolling centrifugal element of FIG. 3;

FIG. 5 is an end perspective view of a spider and rolling centrifugal elements according to one exemplary aspect of the present invention;

FIG. 6 a cross-sectional end perspective view of a housing of a movable sheave assembly and rolling centrifugal elements according to one exemplary aspect of the present invention;

FIG. 7 is a close up view cross-sectional view of a roller centrifugal element within the housing of the movable sheave assembly according to one exemplary aspect of the present invention;

FIG. 8 is a block diagram of a vehicle employing a drive clutch according to one exemplary aspect of the present invention; and

FIG. 9 is a partial cross-sectional close-up view of a moveable sheave member according to one exemplary aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide an improved clutch for a CVT. Embodiments employ rolling centrifugal elements that eliminate a sliding interface between a spider and sheave. In one example, rolling centrifugal elements split a centrifugal element contact between a pair of rollers that contact a spider ramp and a single roller that contacts a sheave ramp. Further in an example embodiment, all three rollers of a rolling centrifugal element are assembled and contained on a central axle with a pair of thrust washers and clips as discussed below in detail.

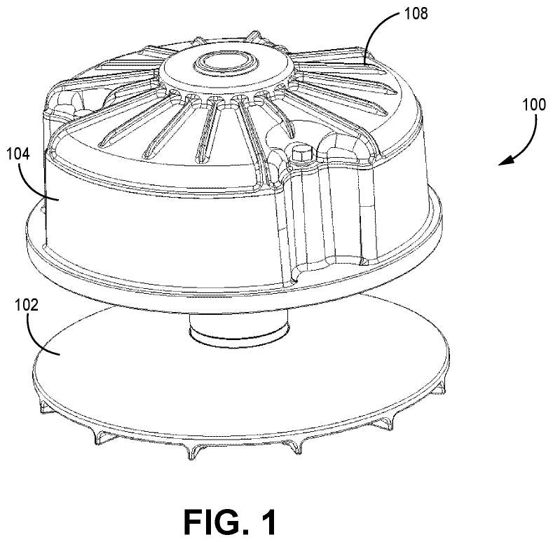

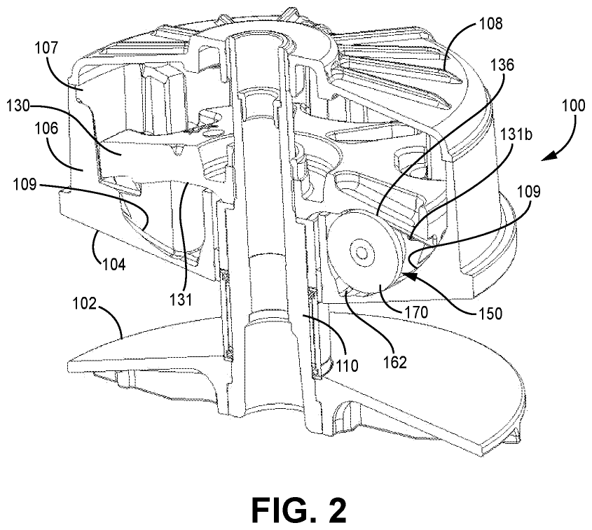

Referring to FIG. 1, an assembled side perspective view of a clutch, such as drive clutch, of a CVT of an example embodiment is illustrated. The drive clutch 100, which may be referred to as a drive sheave, includes a fixed sheave 102 and a movable sheave assembly 104. FIG. 2 illustrates a cross-sectional side view of the drive clutch 100 illustrating a rolling centrifugal element 150 positioned within a housing 106 of the movable sheave assembly 104. The fixed sheave 102 is statically mounted on an end of post 110. Portions of the movable sheave assembly 104 are slidably mounted on the post 110. A spider 130 within the housing 106 of the movable sheave assembly 104, is axially fixed (statically fixed) on the post 110. A cover 108, in this example, engages the housing 106 to form an interior chamber 107 of the movable sheave assembly 104. In another example, the housing 106 on its own is formed to create the interior chamber 107. Within the interior chamber 107 and between the cover 108 and the spider 130 is a main bias member (not shown) that exerts a bias force on the cover 108 to push movable sheave assembly 104 away from the fixed sheave 102 when a centrifugal force that can counter the bias force is not present.

Centrifugal forces, caused by the drive clutch 100 rotating, cause rolling centrifugal elements 150 position between an associated sheave ramp 109 within the housing 106 of the movable sheave assembly 104 and a spider ramp 131 of the spider 130 to push the movable sheave assembly 104 towards the fixed sheave 102. FIG. 2 illustrates a portion of one of the rolling centrifugal elements 150 that is position within rolling centrifugal element pockets 162 between the sheave ramp 109 within the housing 106 of the of the movable sheave assembly 104 and a spider ramp 131 of the spider 130. Drive clutch 100 will include a plurality of rolling centrifugal elements 150 and associated rolling centrifugal element pockets 162. In one example, six ramp/roller pairs are used in a drive clutch with none of the six being aligned 180 degrees from another.

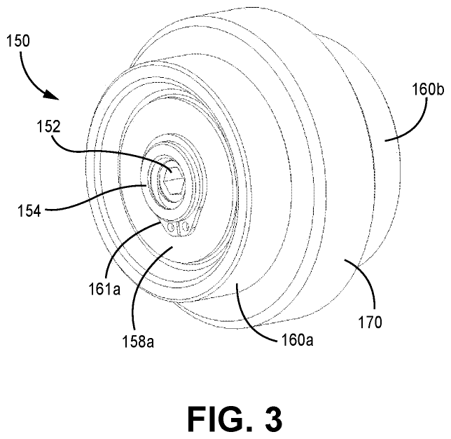

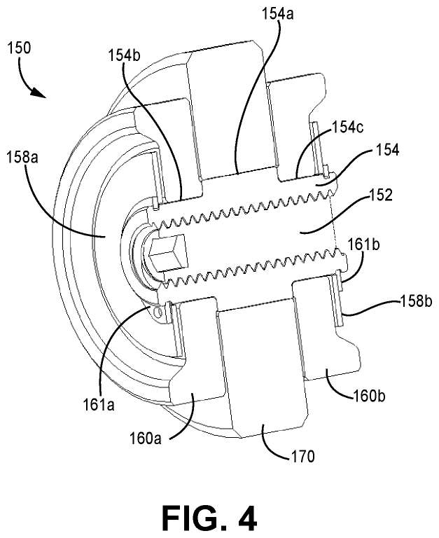

FIG. 3 illustrates a side perspective view of a rolling centrifugal element 150 and FIG. 4 illustrates a cross-sectional side perspective view of the rolling centrifugal element 150 in an example. The rolling centrifugal element 150 includes a centrally positioned sheave ramp roller 170. The sheave ramp roller 170 in this example is positioned between a pair of spider ramp rollers 160a and 160b. The sheave ramp roller 170 in this example, radially extends out from the axle 154 further than the spider ramp rollers 160a and 160b in this example. In one example, a diameter of the sheave ramp roller 170 is larger than the diameter of the than the spider ramp rollers 160a and 160b. Alternatively, in another example, the sheave ramp roller 170 is smaller in diameter than the spider ramp rollers 160a and 160b with the geometry of the sheave ramp and spider ramps adjusted accordingly.

The sheave ramp roller 170 and spider ramp rollers 160a and 160b are mounted on an axle 154. The axle 154 in this example includes a mid-portion 154a upon which the sheave ramp roller 170 is mounted. The mid-portion 154a has a larger dimeter than side portions 154b and 154c upon which the spider ramp rollers 160a and 160b are mounted in this example. Thrust washers 158a and 158b and retaining clips 161a and 161b retain the sheave ramp roller 170 and the spider ramp rollers 160a and 160b on the axle 154. An optional weighted insert 152 may be positioned within a central bore of axle 154.

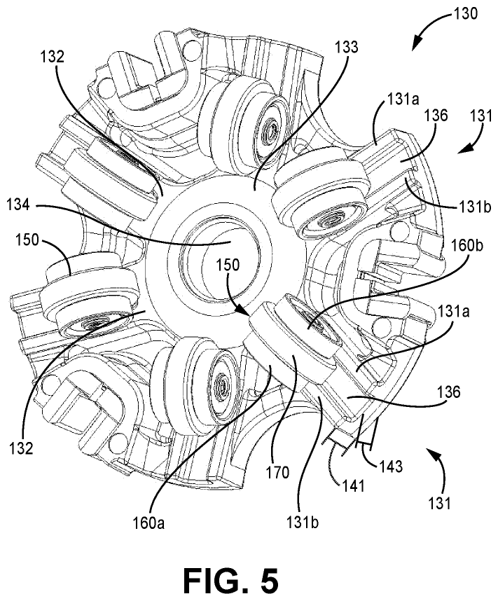

FIG. 5 illustrates an example of a spider 130 with six rolling centrifugal elements 150. The spider 130 includes a base 133 with a central passage 134 that is statically mounted on the post 110. From the base 133, a plurality of spaced spider ramp arms 132, that each include a spider ramp 131, radially extend. Each ramp arm 132 includes a pair of spider ramp portions 131a and 131b that are spaced by a non-contact portion 136. The spider ramp rollers 160a and 160b of an associated centrifugal element 150 are designed to engage spider ramp portions 131a and 131b of an associated spider ramp arm 132 of the spider 130 while the sheave ramp roller 170 of the associated centrifugal element 150 is positioned within the associated non-contact portion 136 of the spider ramp arm 132. Hence, in the example, the spider ramp rollers 160a and 160b of each rolling centrifugal element 150 engages the spider while the sheave ramp roller 170 of each rolling centrifugal element 150 does not contact the spider 130. This is achieved in this example by the spider ramp portions 131a and 131b having a first axial height 141 that is off set from a second axial height 143 of the non-contact portion 136. In this example, the first axial height 141 is greater than the second axial height 143.

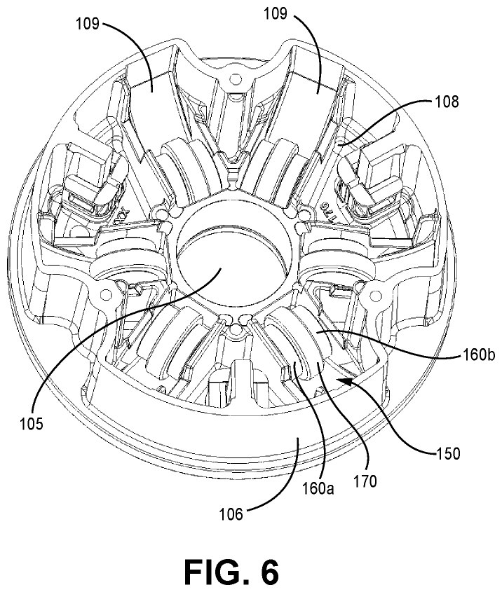

FIG. 6 illustrates a cross-sectional end perspective view of an example of the housing 106 of the movable sheave assembly 104. Within the housing 106 is formed, or positioned, the plurality of the sheave ramps 109. The housing in this example, includes a central housing opening 105. The central housing opening 105 slidably receives the post 110. Also illustrated in this example is the positioning of the rolling centrifugal elements 150 associated with each sheave ramp 109. The sheave ramp roller 170 of each rolling centrifugal element 150 engages an associated sheave ramp 109 while the spider ramp rollers 160a and 160b of each rolling centrifugal element 150 do not contact the associated sheave ramp 109 in this example.

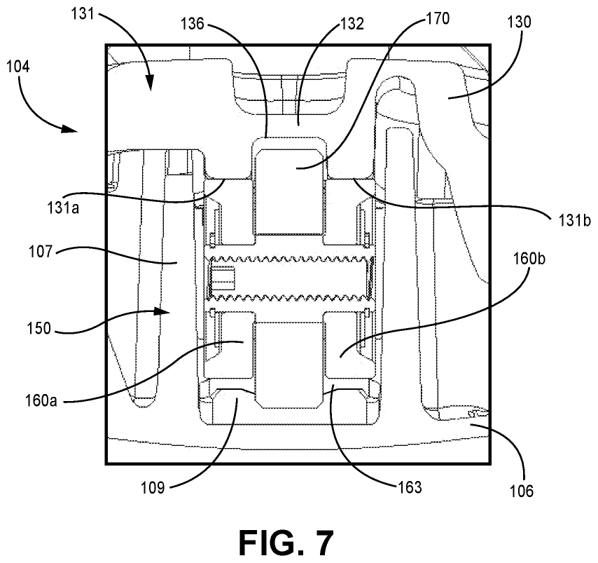

Referring to FIG. 7, a close-up view of a spider ramp arm 132 of the spider 130, a rolling centrifugal element 150 and the sheave ramp 109 within the housing 106 of the movable sheave assembly 104 is illustrated. As illustrated, the center sheave ramp roller 170 of the rolling centrifugal element 150 engages the sheave ramp 109 within the interior chamber 107 of the movable sheave assembly 104 but not the spider ramp portions 131a and 131b. The positioning of the central sheave ramp roller 170 places the sheave ramp roller 170 within the non-contact portion 136 of the spider ramp 131 between the spider ramp portions 131a and 131b. Further, the outside spider ramp rollers 160a and 160b of the rolling centrifugal element 150 engage the spider ramp portions 131a and 131b of the spider 130 but not the sheave ramp 109 of the movable sheave assembly 104 as illustrated by gap 163. Hence, in the example shown, the spider ramp rollers 160a and 160b of the rolling centrifugal element 150 engage the spider 130 while the center sheave ramp roller 170 of the rolling centrifugal element 150 engages the movable sheave assembly 104.

By splitting the roller contact surfaces between the spider 130 and movable sheave assembly 104, the centrifugal elements 150 can perform under rolling contact vs sliding contact. The rolling contact of the centrifugal elements 150 reduces friction in the system and allows the drive clutch 100 to respond easier to changes in vehicle dynamics. The result is a better performing CVT having consistent shift characteristics and improved durability. Further, the design provides for better drivability characteristics, disengagement characteristics, back shifting characteristics as well as less wear than known designs.

In one example, the sheave ramp roller 170 is pressed fitted on the mid-portion 154a of the axle 154 and the outside spider ramp rollers 160a and 160b are mounted on the respective side portions 154b and 154c of axle via thrust washers 158a and 158b and retaining clips 161a and 161b. In one example, the sheave ramp roller 170 and outside spider ramp rollers 160a and 160b are made with an over-mold plastic. In another example, they are solid polymer rollers. The axle material may be varied to achieve a mass adjustment in an example embodiment. Further in one example, all rollers 160a, 160b and 170 are free to rotate in relation to the axle. In addition, in one example, the sheave ramp roller 170 is integral to axle 154. Moreover, the design allows the sheave ramp roller 170 to rotate in the opposite direction than the outside spider ramp rollers 160a and 160b.

In another embodiment, there are two sheave ramp rollers and one spider ramp roller. Further in this example, there are two ramp surfaces within the housing of the movable sheave assembly for each rolling centrifugal element and one ramp surface on each arm of the spider. Hence, other rolling centrifugal element configurations are contemplated to achieve separate engagement of the spider ramps and sheave ramps.

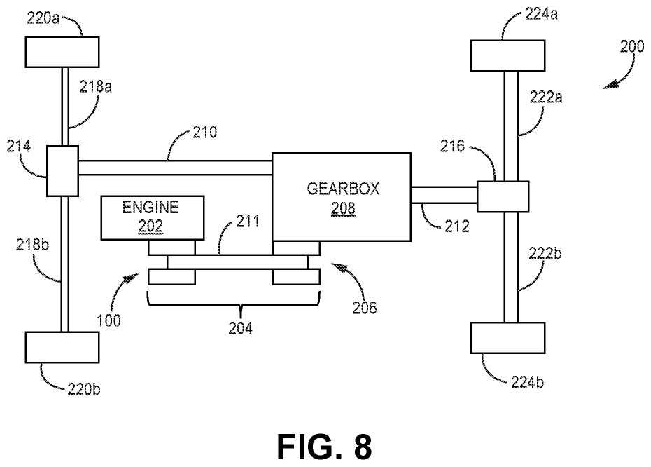

Referring to block diagram of FIG. 8, an example vehicle 200 implementing a drive clutch 100 described above is illustrated. The drive clutch 100 is part of a CVT 204 that further includes an endless looped member 211 (that may be a belt) and a driven clutch 206. The drive clutch 100 is in operational communication with an engine 202 to receive engine torque. The driven clutch 206 is in operational communication with the drive clutch 100 via the endless looped member 211 to selectively communicate torque between the drive clutch 100 and the driven clutch 206.

The driven clutch 206 is in communication with a driveline that, in this example, includes a gear box 208. The vehicle 200 in this example includes a rear differential 216 that is in operational communication with the gear box 208 via rear prop shaft 212. The rear differential is in operational communication with rear wheels 224a and 224b via respective prop shafts 222a and 222b.

Further in this example, the vehicle includes a front differential 214 that is in operational communication with the gear box 208 via front prop shaft 210. The front differential is in communication with the front wheels 220a and 220b via front half shafts 218a and 218b. Other vehicle configurations may use the drive clutch 100 described above including, tracked vehicles, as well as any other types of vehicles that employ a CVT system.

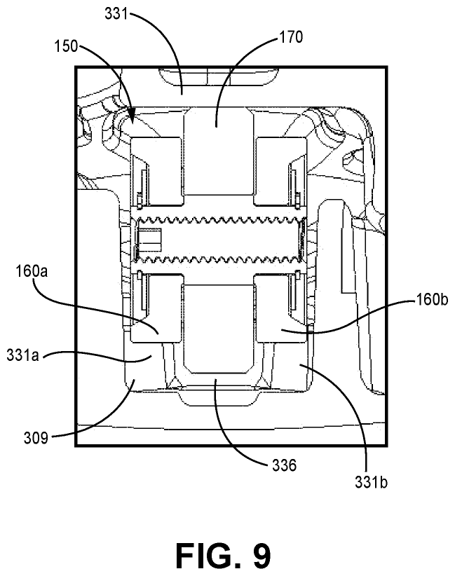

An example of an arrangement where the spider ramp 331 is designed to engage the sheave ramp roller 170 while the spider ramp rollers 160a and 160b of the rolling centrifugal elements 150 engage sheave ramp portions 331a and 331b of a sheave ramp 309 is illustrated in FIG. 9. As illustrated in the partial cross-sectional close-up view of a moveable sheave member of FIG. 9, the sheave ramp roller 170 in this example is received in a non-contact portion 336 of the sheave ramp 309. Hence, different configurations of spider ramps and sheave ramps may be used to separately engage the sheave ramp roller 170 and spider ramp rollers 160a and 160b of the rolling centrifugal elements 150. Further as discussed above, the rolling centrifugal elements 150 may have a different configuration to separately engage the spider ramps and sheave ramps.

### EXAMPLE EMBODIMENTS

Example 1 includes a drive clutch for a continuously variable transmission. The drive clutch includes a post, a fixed sheave, a movable sheave assembly, a plurality of spaced sheave ramps, a spider, and a plurality of roller centrifugal elements. The fixed sheave is statically mounted on an end of the post. The movable sheave assembly is slidably mounted on the post. The movable sheave assembly includes a housing that forms at least in part an interior chamber. The plurality of spaced sheave ramps are positioned within the interior chamber of the housing of the movable sheave assembly. The spider is received within the housing of the movable sheave assembly. The spider is statically mounted on the post. The spider includes a plurality of spaced radially extending spider ramp arms. Each spider ramp arm includes at least one spider ramp. The plurality of roller centrifugal elements are received within the interior chamber of the housing of the movable sheave. Each roller centrifugal element includes at least one sheave ramp roller and at least one spider ramp roller. The at least one sheave ramp roller is configured to engage one of an associated sheave ramp and associated spider ramp and the at least one spider ramp roller configured to engage another one of the associated sheave ramp and associated spider ramp.

Example 2 includes the drive clutch of Example 1, wherein each spider ramp further includes at least one spider ramp portion and a non-contact portion. The at least one sheave ramp roller of an associated roller centrifugal element is configured to be positioned within the non-contact portion of an associated spider ramp.

Example 3 includes the drive clutch of any of the Example 1, wherein each spider ramp further includes a pair of spider ramp portions and a non-contact portion. The non-contact portion is positioned between the pair of spider portions. The at least one spider ramp roller of an associated roller centrifugal element includes a pair of spider ramp rollers. Each spider roller of the pair of spider rollers engages one spider ramp portion of the pair of spider ramp portions of an associated spider ramp. The at least one sheave ramp roller of an associated roller centrifugal element is configured to be positioned within the non-contact portion of an associated spider ramp.

Example 4 includes the drive clutch of Example 3, wherein the pair of spider ramp portions have a first height that is offset from a second height of the non-contact portion.

Example 5 includes the drive clutch of any of the Examples 3-4, further including an axle for each roller centrifugal element. An associated pair of spider ramp rollers and sheave ramp roller are mounted on each axle.

Example 6 includes the drive clutch of Example 5, further wherein each axle includes a central bore. A weight is positioned within the central bore.

Example 7 includes the drive clutch of any of the Examples 1-6, wherein the at least one sheave ramp roller of each roller centrifugal element extends radially outward farther than the at least one spider ramp roller.

Example 8 includes the drive clutch of any of the Examples 1-7, wherein the at least one sheave ramp roller and at least one spider ramp roller are free to rotate independent of each other on an axle.

Example 9 includes the drive clutch of any of the Examples 1-8, further including a cover coupled to the housing to form the interior chamber.

Example 10 includes a rolling centrifugal element for a clutch of a continuously variable transmission. The rolling centrifugal element includes an axle and at least one sheave ramp roller and at least one spider ramp roller mounted on the axle. The at least one sheave ramp roller is configured to engage one of an associated sheave ramp of a movable sheave assembly of the clutch and an associated spider ramp of a spider and the at least one spider ramp roller configured to engage another one of the associated sheave ramp and the associated spider ramp. The at least one sheave ramp roller is configured to rotate independent of the at least one sheave ramp roller.

Example 11 includes the rolling centrifugal element of Example 10, wherein one of the at least one sheave ramp roller and the at least one spider ramp roller extends radially outward farther than the other one of the at least one sheave ramp roller and the at least one spider ramp roller.

Example 12 includes the rolling centrifugal element of any of the Examples 10-11, wherein the at least one spider ramp roller includes a pair of spider ramp rollers. The at least one sheave ramp roller is configured to be positioned within the non-contact portion of an associated spider ramp.

Example 13 includes the rolling centrifugal element of any of the Examples 10-12, further including a weight insert received within a central bore of the axle.

Example 14 includes the rolling centrifugal element of any of the Examples 10-13, wherein the axle further includes a mid-portion, a first side portion and second side portion. The at least one sheave ramp roller is mounted on the mid-portion of the axle. One spider ramp of the pair of the spider ramps is mounted on the first side portion. Another spider ramp of the pair of the spider ramps is mounted on the second side portion. The mid-portion is positioned between the first side portion and the second side portion.

Example 15 includes the rolling centrifugal element of Example 14, wherein the mid-portion of the axle has a larger diameter than a diameter of the first and second side portions of the axle.

Example 16 includes the rolling centrifugal element of and of the Examples 10-15, wherein at least one of the at least one sheave ramp roller and the at least one spider ramp roller is rotationally mounted on the axle.

Example 17 includes a vehicle. The vehicle includes an engine to produce engine torque, a driveline and a CVT. The CVT includes a driven clutch and a drive clutch. The driven clutch is in operational communication with the driveline. The drive clutch is in operational communication with the engine. The drive clutch includes a post, a fixed sheave, a movable sheave assembly, a plurality of spaced sheave ramps, a spider, and a plurality of roller centrifugal elements. The fixed sheave is statically mounted on an end of the post. The movable sheave assembly is slidably mounted on the post. The movable sheave assembly includes a housing that forms at least in part an interior chamber. The plurality of spaced sheave ramps are positioned within the interior chamber of the housing of the movable sheave assembly. The spider is received within the housing of the movable sheave assembly. The spider is statically mounted on the post. The spider includes a plurality of spaced radially extending spider ramp arms. Each spider ramp arm includes at least one spider ramp. The plurality of roller centrifugal elements are received within the interior chamber of the housing of the movable sheave. Each roller centrifugal element includes at least one sheave ramp roller and at least one spider ramp roller. The at least one sheave ramp roller is configured to engage one of an associated sheave ramp and associated spider ramp and the at least one spider ramp roller configured to engage another one of the associated sheave ramp and associated spider ramp. An endless looped member couples torque between the drive clutch and the driven clutch.

Example 18 includes the vehicle of Example 17, wherein each spider ramp further includes a pair of spider ramp portions and a non-contact portion. The non-contact portion is positioned between the pair of spider portions. The at least one spider ramp roller of an associated roller centrifugal element includes a pair of spider ramp rollers. Each spider roller of the pair of spider rollers engages one spider ramp portion of the pair of spider ramp portions of an associated spider ramp. The at least one sheave ramp roller of an associated roller centrifugal element is configured to be positioned within the non-contact portion of an associated spider ramp.

Example 19 includes the vehicle of any of the Examples 17-18, wherein the at least one sheave ramp roller and at least one spider ramp roller are free to rotate independent of each other on an axle.

Example 20 includes the vehicle of any of the Examples 17-19, wherein one of the at least one sheave ramp roller and the at least one spider ramp roller extends radially outward farther than the other one of the at least one sheave ramp roller and the at least one spider ramp roller.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A drive clutch for a continuously variable transmission, the drive clutch comprising:
a post;
a fixed sheave statically mounted on an end of the post;
a movable sheave assembly slidably mounted on the post, the movable sheave assembly including a housing that forms at least in part an interior chamber;
a plurality of spaced sheave ramps positioned within the interior chamber of the housing of the movable sheave assembly;
a spider received within the housing of the movable sheave assembly, the spider statically mounted on the post, the spider including a plurality of spaced radially extending spider ramp arms, each spider ramp arm including at least one spider ramp; and
a plurality of roller centrifugal elements received within the interior chamber of the housing of the movable sheave, each roller centrifugal element including at least one sheave ramp roller and at least one spider ramp roller, the at least one sheave ramp roller configured to engage one of an associated sheave ramp and associated spider ramp and the at least one spider ramp roller configured to engage another one of the associated sheave ramp and associated spider ramp.

2. The drive clutch of claim 1, wherein each spider ramp further comprises:
at least one spider ramp portion and a non-contact portion, the at least one sheave ramp roller of an associated roller centrifugal element configured to be positioned within the non-contact portion of an associated spider ramp.

3. The drive clutch of claim 1, wherein each spider ramp further comprises:
a pair of spider ramp portions and a non-contact portion, the non-contact portion positioned between the pair of spider portions;
the at least one spider ramp roller of an associated roller centrifugal element including a pair of spider ramp rollers, each spider roller of the pair of spider rollers engaging one spider ramp portion of the pair of spider ramp portions of an associated spider ramp; and
the at least one sheave ramp roller of an associated roller centrifugal element configured to be positioned within the non-contact portion of an associated spider ramp.

4. The drive clutch of claim 3, wherein the pair of spider ramp portions have a first height that is offset from a second height of the non-contact portion.

5. The drive clutch of claim 3, further comprising:
an axle for each roller centrifugal element, an associated pair of spider ramp rollers and sheave ramp roller mounted on each axle.

6. The drive clutch of claim 5, further wherein each axle includes a central bore, a weight positioned within the central bore.

7. The drive clutch of claim 1, wherein the at least one sheave ramp roller of each roller centrifugal element extends radially outward farther than the at least one spider ramp roller.

8. The drive clutch of claim 1, wherein the at least one sheave ramp roller and at least one spider ramp roller are free to rotate independent of each other on an axle.

9. The drive clutch of claim 1, further comprising:
a cover coupled to the housing to form the interior chamber.

10. A rolling centrifugal element for a clutch of a continuously variable transmission, the rolling centrifugal element comprising:
an axle; and
at least one sheave ramp roller and at least one spider ramp roller mounted on the axle, the at least one sheave ramp roller configured to engage one of an associated sheave ramp of a movable sheave assembly of the clutch and an associated spider ramp of a spider and the at least one spider ramp roller configured to engage another one of the associated sheave ramp and the associated spider ramp, the at least one sheave ramp roller configured to rotate independent of the at least one sheave ramp roller.

11. The rolling centrifugal element of claim 10, wherein one of the at least one sheave ramp roller and the at least one spider ramp roller extends radially outward farther than another one of the at least one sheave ramp roller and the at least one spider ramp roller.

12. The rolling centrifugal element of claim 10, wherein the at least one spider ramp roller includes a pair of spider ramp rollers, the at least one sheave ramp roller configured to be positioned within a non-contact portion of an associated spider ramp.

13. The rolling centrifugal element of claim 12, further comprising:
a weight insert received within a central bore of the axle.

14. The rolling centrifugal element of claim 12, wherein the axle further comprises:
a mid-portion, the at least one sheave ramp roller is mounted on the mid-portion of the axle;
a first side portion, one of the pair of the spider ramps mounted on the first side portion; and
a second side portion, another one of the pair of the spider ramps mounted on the second side portion, the mid-portion positioned between the first side portion and the second side portion.

15. The rolling centrifugal element of claim 14, wherein the mid-portion of the axle has a larger diameter than a diameter of the first and second side portions of the axle.

16. The rolling centrifugal element of claim 10, wherein at least one of the at least one sheave ramp roller and the at least one spider ramp roller is rotationally mounted on the axle.

17. A vehicle comprising:
an engine to produce engine torque;
a driveline;
a continuously variable transmission (CVT) including,
a driven clutch in operational communication with the driveline;
a drive clutch in operational communication with the engine, the drive clutch including,
a post;
a fixed sheave statically mounted on an end of the post;
a movable sheave assembly slidably mounted on the post, the movable sheave assembly including a housing that forms at least in part an interior chamber;
a plurality of spaced sheave ramps positioned within the interior chamber of the housing of the movable sheave assembly;
a spider received within the housing of the movable sheave assembly, the spider statically mounted on the post, the spider including a plurality of spaced radially extending spider ramp arms, each spider ramp arm including at least one spider ramp; and
a plurality of roller centrifugal elements received within the interior chamber of the housing of the movable sheave, each roller centrifugal element including at least one sheave ramp roller and at least one spider ramp roller, the at least one sheave ramp roller configured to engage one of an associated sheave ramp and associated spider ramp and the at least one spider ramp roller configured to engage another one of the associated sheave ramp and associated spider ramp; and
an endless looped member coupling torque between the drive clutch and the driven clutch.

18. The vehicle of claim 17, wherein each spider ramp further comprises:
a pair of spider ramp portions and a non-contact portion, the non-contact portion positioned between the pair of spider portions;
the at least one spider ramp roller of an associated roller centrifugal element including a pair of spider ramp rollers, each spider roller of the pair of spider rollers engaging one spider ramp portion of the pair of spider ramp portions of an associated spider ramp; and
the at least one sheave ramp roller of an associated roller centrifugal element configured to be positioned within the non-contact portion of an associated spider ramp.

19. The vehicle of claim 17, wherein the at least one sheave ramp roller and at least one spider ramp roller are free to rotate independent of each other on an axle.

20. The vehicle of claim 17, wherein one of the at least one sheave ramp roller and the at least one spider ramp roller extends radially outward farther than another one of the at least one sheave ramp roller and the at least one spider ramp roller.
